(19) United States
(12) Patent Application Publication
(10) Pub. No.: US 2011/0280193 A1
(43) Pub. Date: Nov. 17, 2011

(54) DOWNLINK CONTROL CHANNEL-TO-RESOURCE ELEMENT MAPPING

(75) Inventors: Lars E. Lindh, Helsingfors (FI); Frank Frederiksen, Klarup (DK); Jussi K. Ojala, Helsinki (FI); Jaako Eero Visuri, Helsinki (FI)

(73) Assignee: NOKIA CORPORATION, Espoo (FI)

(21) Appl. No.: 12/678,305

(22) PCT Filed: Sep. 23, 2008
(86) PCT No.: PCT/IB2008/053867

§ 371 Date: Jun. 30, 2010

Related U.S. Application Data
(60) Provisional application No. 60/995,289, filed on Sep. 25, 2007.

(51) Int. Cl. H04W 72/04

(52) U.S. Cl. 370/329

(57) ABSTRACT

In accordance with an exemplary embodiment of the invention, one or more first channels and one or more second channels are stored in a linear buffer. More specifically, the one or more first channels are stored in a first primary region of the linear buffer, and the one or more second channels are stored in a second primary region of the linear buffer, where if the second primary region is not large enough to store all of the second channels, one or more excess second channels are stored in a secondary area of the linear buffer.

### TECHNICAL FIELD

The exemplary and non-limiting embodiments of this invention relate generally to wireless communication systems, methods, devices and computer program products and, more specifically, relate to techniques to provide downlink (DL) control channel signaling to a plurality of user equipments (UEs).

### BACKGROUND

Various abbreviations that may appear in the specification and/or in the drawing figures are defined as follows:

3GPP third generation partnership project
UTRAN universal terrestrial radio access network
Node B base station
UE user equipment
EUTRAN evolved UTRAN
aGW access gateway
eNB EUTRAN Node B (evolved Node B)
CCE control channel element
RE resource element
BCH broadcast channel
ARQ automatic repeat request
PCFICH physical control format indicator channel
PHICH physical hybrid-ARQ indicator channel
PDCCH physical downlink control channel
LTE long term evolution
BW bandwidth
ACK acknowledge
NACK not (negative) acknowledge
OFDMA orthogonal frequency division multiple access
SC-FDMA single carrier, frequency division multiple access
UL uplink
DL downlink

A proposed communication system known as evolved UTRAN (E-UTRAN, also referred to as UTRAN-LTE or as E-UTRA) is under development within the 3GPP. The current working assumption is that the DL access technique will be OFDMA, and the UL access technique will be SC-FDMA.

One specification of interest to these and other issues related to the invention is 3GPP TS 36.300, V8.0.0 (2007-03), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8).

In many wireless communication systems a base station (sometimes referred to as a Node-B and, in the LTE system as the eNode-B or eNB) communicates with the user terminals or UEs in a frame using point-to-multipoint transmissions. A part of the DL transmission is reserved for a control channel which defines how the resources in the frame are to be used by the UEs.

The control channel is individually coded for each UE and contains a number of CCEs, which are composed of a certain number of REs, where a RE can be considered to be a subcarrier symbol in an OFDM system. In LTE it is currently assumed that a CCE consists of 36 REs, however this value is subject to change, and may eventually be defined as 42 or 48 REs.

Related to the control channels are the acknowledgment channels (in LTE known as PHICH), on which responses (ACK/NACK) are transmitted to indicate the success or failure of previous uplink transmissions/receptions.

There is also a BCH, which is received by every UE and which carries both static system information (such as the system bandwidth) and semi-static information, which is updated at a low rate (for example, the numbers of ACK/NACK channels).

As presently defined the DL control signaling uses three channels, i.e., the PCFICH, the PHICH and the PDCCH. The definitions of these channels are as follows. Reference can also be made to 3GPP TS 36.211 V2.0.0 (2007-09), Technical Specification, 3rd Generation Partnership Project; Technical Specification Group Radio Access Network; Evolved Universal Terrestrial Radio Access (E-UTRA); Physical Channels and Modulation (Release 8).

PCFICH: Occurs in the first OFDM symbol in each subframe and indicates the number of OFDM symbols assigned to DL control signaling. PCFICH is protected with heavy coding and the indicated value is in the range 1-3 for the FDD mode. PCFICH is always located in the first OFDM symbol in the subframe and consists of 16 REs.

PHICH: Carries the ACK/NACK signals corresponding to previous uplink transmissions. The PHICHs can be sent in one or three control symbols.

PDCCH: These control channels contain the DL-grants and UL-grants for the UEs, as well as certain special formats including the dynamic part of the broadcast channel. One PDCCH is aggregated from one or several CCEs

In addition to these channels the eNB needs to transmit reference symbols (common pilots) in order to provide coherent demodulation at the UEs. The amount of reference symbols transmitted depends on the antenna configuration at the eNB, and is assumed to be known at the UE.

The power of the individual control channels can be balanced in such a way that a channel intended for those UEs located at the cell edge (those farthest from the eNB) can use more power than the channels intended for those UEs closer to the eNB.

The control channel-to-RE mapping is required to guarantee:

Frequency diversity—that is, they should be mapped over the entire system bandwidth; and
Power averaging—that is, the CCEs should be spread over all control channel symbols (time-wise) in order to average the transmit power.

It has also been agreed that the mapping of CCEs occurs in blocks of four adjacent REs, known as a miniCCE, in order to support space-frequency block coded (SFBC) multi-antenna systems. However, this mapping of the CCEs is complicated by the fact that the size of the control channel OFDM symbols are of unequal size due to the reference symbols. In addition, the UE must be able to decode the control channel without assuming that it has a priori knowledge of any semi-static settings.

At the time of this application, the 3GPP LTE has not adopted any solutions for the control channel-to-RE mapping and, unfortunately, a decision has been made in LTE that the number of PHICHs, and the number of symbols they are mapped to, are semi-statically set. The inventors have realized that this has the potential to create a problem if the UE must read the dynamic broadcast channel in order to be able to access the control channel, and must also read the control channel in order to be able to access the dynamic broadcast channel.

Reference with regard to a prior proposal (not accepted) can be made to 3GPP TSG-RAN WG1 Meeting #50, R1-073290, Athens, Greece, Aug. 20-24, 2007, “The Resource Element Mapping of PDCCH, PCFICH and PHICH”, Nortel.

### SUMMARY

In an exemplary aspect of the invention, there is a method comprising storing one or more first channels in a first primary region of a linear buffer, and storing one or more second channels in a second primary region of the linear buffer, where if the second primary region is not large enough to store all of the second channels, one or more excess second channels are stored in a secondary area of the linear buffer.

In another exemplary aspect of the invention, there is a computer readable medium encoded with a computer program executable by a processor to perform actions comprising storing one or more first channels in a first primary region of a linear buffer, and storing one or more second channels in a second primary region of the linear buffer, where if the second primary region is not large enough to store all of the second channels, one or more excess second channels are stored in a secondary area of the linear buffer.

In yet another exemplary aspect of the invention, there is an apparatus comprising a memory, a controller configured to store one or more first channels in a first primary region of a linear buffer in the memory, the controller further configured to store one or more second channels in a second primary region of the linear buffer, and the controller further configured to respond to a condition where the second primary region is not large enough to store all of the second channels, to store one or more excess second channel in a secondary area of the linear buffer in the memory.

In still another exemplary aspect of the invention, there is an apparatus comprising means for storing one or more first channels in a first primary region of a linear buffer, and means for storing one or more second channels in a second primary region of the linear buffer, and means, responsive to a condition where the second primary region is not large enough to store all of the second channels, for storing one or more excess second channels in a secondary area of the linear buffer.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2 illustrates a Table 1 that shows a number of resource blocks, miniCCEs for short and long symbols and suggested step sizes;

FIG. 3 illustrates the division of a control resource into different areas;

FIG. 4 depicts an example of a mapping to three control symbols with a 1.4 MHz bandwidth, where the PDCCH region starts at index 7, which is mapped to symbol 1, offset 6;

FIG. 5 shows an example of control channel areas in a case where the PHICH uses one OFDM control symbol and the control channel uses more than one symbol, where in this example the primary PHICH area is fragmented by the primary PDCCH area; and

FIG. 6 is a logic flow diagram in accordance with a method, and the operation of a computer program, in accordance with an exemplary embodiment of this invention.

### DETAILED DESCRIPTION

The exemplary embodiments of this invention provide a novel approach to the control channel-to-RE mapping, which satisfies the frequency diversity requirements and power averaging requirements, while at the same time solving the problem referred to above, by the use of a mapping structure that does not require the UE to explicitly know the number of PHICHs.

Reference with regard to this invention can be made to the inventor's contribution to 3GPP TSG RAN WG1 Meeting #50bis, R1-074318, Shanghai, China, Oct. 8-12, 2007, “Control channel to RE mapping”, Nokia.

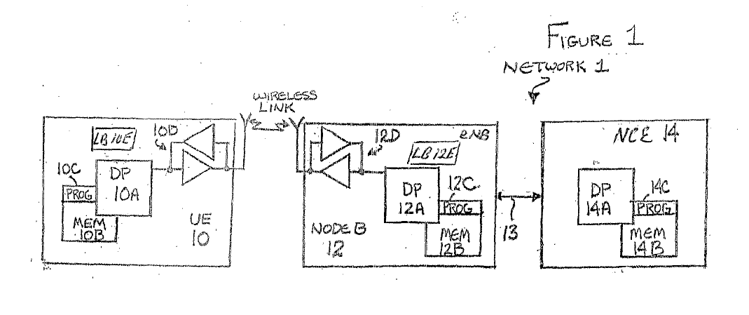

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12, also referred to here as an eNB 12. The network 1 may include a network control element (NCE) 14, such as an aGW. The UE 10 includes a data processor (DP) 10A, a memory (MEM) 10B that stores a program (PROG) 10C, and a suitable radio frequency (RF) transceiver 10D for bidirectional wireless communications with the eNB 12, which also includes a DP 12A, a MEM 12B that stores a PROG 12C, and a suitable RF transceiver 12D. The eNB 12 is coupled via a data path 13 to the NCE 14 that also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNB 12, or by hardware, or by a combination of software and hardware. It is noted that any of these devices may have multiple processors (e.g. RF, baseband, imaging, user interface) which operate in a slave relation to a master processor. The teachings may be implemented in any single one or combination of those multiple processors.

For the purposes of describing the exemplary embodiments the eNB 12 and the UE 10 may include a buffer that may form a part of the MEM 10B or MEM 12B. The buffer may be a linear buffer LB 10E or LB 12E as illustrated in FIG. 1, the use of which is described below.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

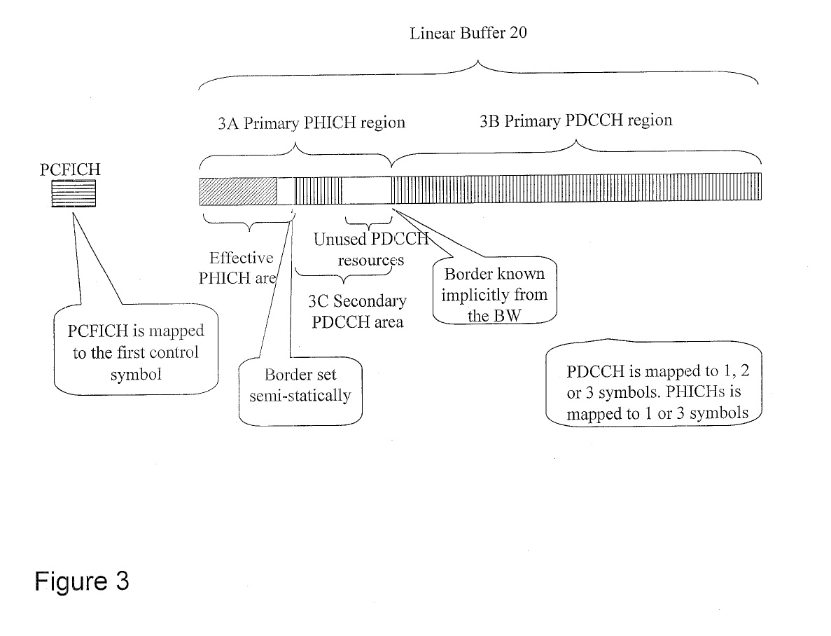

Discussing now the exemplary embodiments of this invention in greater detail, FIG. 3 shows the grouping of the PCFICH, PHICH and PDCCH to different regions before the mapping. The PCFICH always consists of 16 symbols which are mapped to the first control symbol and can be treated differently. The PDCCH is mapped to all control symbols (1-3). The PHICH is mapped to one or three constant symbols depending on semi-static settings.

The PDCCH and PHICH are placed into a linear buffer 20, where the first portion is primarily reserved for the PHICH and which is sized to accommodate the maximum number of PHICHs. Note that this value is known to the UE 10 implicitly from the system bandwidth.

First, the PHICHs are stored into a PHICH primary region 3A, which as a result may be only partially filled. Second, the PDCCHs are stored into a PDCCH primary region 3B. If this region is not sufficient the remaining PDCCHs are stored in a secondary PDCCH area 3C after the already stored PHICHs.

As should be appreciated, by the use of this technique the UE 10 does not need to know the number of PHICHs in order to access the first part of the PDCCHs, which are found in their predetermined primary region 3B. It is assumed that when important semi-static configuration data is transmitted it is signaled in the first part of the primary PDCCH region 3B.

The mapping to miniCCEs is made by transforming the linear index from the buffer 20 into a 2-dimensional (symbol, miniCCE offset) address. This may be accomplished in a diagonal manner, where adjacent indices are mapped to different parts of the frequency band and to the next symbol (if there are more than one control symbol). The move from one index to another is defined by a step size, which is a prime number and dependent on the bandwidth. The mapping operation is complicated by the fact that PCFICHs are already placed in the first symbol, and by the fact that the effective size of the symbols is different due to the reference symbols.

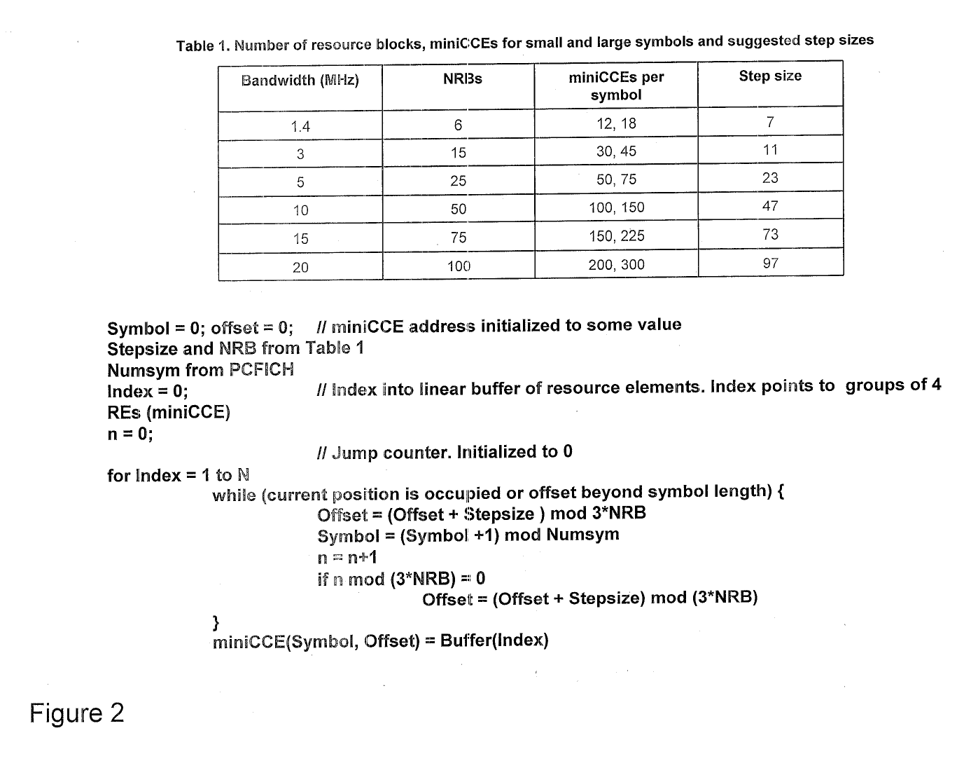

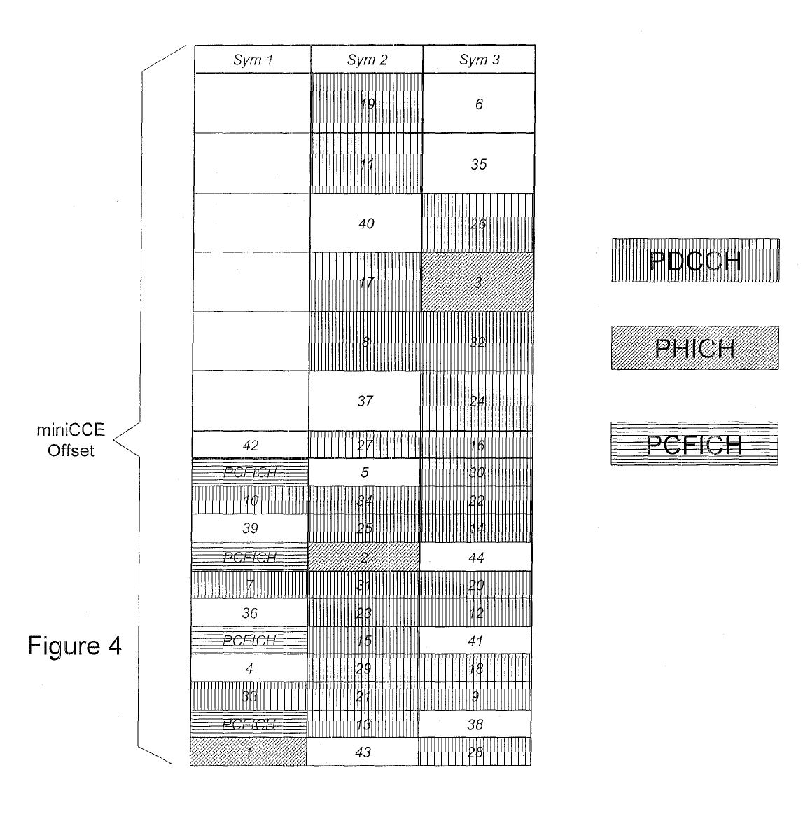

FIGS. 3 and 4 show the concepts involved in the mapping, and the Table 1 shown in FIG. 2 illustrates the symbols sizes and suggested step sizes for different bandwidths. Because of the fact that the step size is a prime number, it can be ensured that each position in the control symbols is visited only once.

The pseudo-code shown below the Table in FIG. 2, and reproduced below, defines the details of the mapping operation. The same pseudo-code approach can be used for mapping both the PDCCH and the PHICH.

| | |
|---|---|
| Symbol = 0; offset = 0; | // miniCCE address initialized to some value |

Stepsize and NRB from Table 1
Numsym from PCFICH

| | |
|---|---|
| Index = 0; | // Index into linear buffer of resource elements. Index points to |
| | groups of 4 REs (miniCCE) |

| | |
|---|---|
| n = 0; | // Jump counter. Initialized to 0 |

for Index = 1 to N

while (current position is occupied or offset beyond symbol length) {

Offset = (Offset + Stepsize ) mod 3*NRB
Symbol = (Symbol +1) mod Numsym
n = n+1
if n mod (3*NRB) = 0

Offset = (Offset + Stepsize) mod (3*NRB)

}
miniCCE(Symbol, Offset) = Buffer(Index)

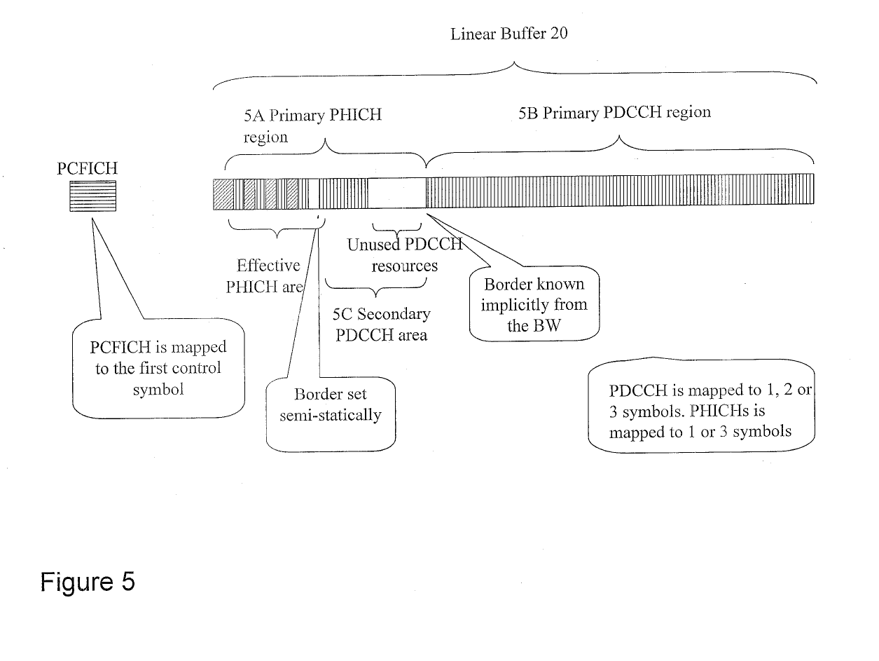

FIG. 5 shows an example of mapping for a case where the PHICH uses one OFDM symbol and the control channel uses more than one. FIG. 5 illustrates the control channel regions in the case that the PHICH uses one OFDM control symbol and the PDCCHs use more than one symbol. Here the effective PHICH area 5C, of the primary PHICH region 5A, is fragmented by the primary PDCCH region 5B.

In summary, and referring again to FIG. 3, the linear buffer 20 begins with the PHICH region 3A (at index 1) and continues with the PDCCH region 3B. As such, the mapping begins from the PHICH region. However, the UE 10 knows where the PDCCH region 3B begins, as both the index and symbol offset are known implicitly from the BW. The UE 10 then begins to read from the PDCCH region 3B because in the primary PDCCH region 3B the UE 10 expects to find broadcast information. It is noted that the linear buffer 20 is marked in FIG. 3 and FIG. 5. Any identification of coverage as it relates to the linear buffer 20 is non-limiting and may be interpreted to include more or less coverage than is illustrated by these markings.

The function index->(sym, offset) is created with the pseudo-code described above. In the example provided the number 7 is added to the offset, the symbol count is incremented and a modulo operation is performed to maintain the symbol and offset values within prescribed limits.

In FIG. 4 three OFDM symbols are shown (the control channel) with the symbol number on the horizontal axis (designated as sym1, sym2 and sym3) and the miniCCE offset on the vertical axis. The first symbol contains fewer miniCCEs and, as a result, may have a smaller maximal offset than symbols 2 and 3. One may also consider that the horizontal axis (symbol number) corresponds to a time axis and that the vertical axis (miniCCE offset) corresponds to a frequency axis.

The index defines a position in the linear buffer 20, and the 2-dimensional address defines a symbol and its offset. FIG. 4 may be interpreted as (in this non-limiting example):

| Index | is mapped to (sym, offset) |
|---|---|
| 1 | 1, 0 |
| 2 | 2, 7 |
| 3 | 3, 14 |
| 4 | 1, 3 |
| and so on. | |

The above-described mapping technique satisfies the basic frequency diversity requirements and power averaging requirements mentioned above, and it also allows the UE 10 to read the PDCCH portion of the control channel without prior knowledge of any semi-static settings.

In addition, the exemplary embodiments of this invention can be readily implemented at both the eNB 12 to provide the mapping and at the UE 10 to decode the mapping, and furthermore are readily scalable to different bandwidths. In general, the algorithm embodied by the pseudo-code example given above is generic and is operable for all system bandwidths.

Based on the foregoing it should be apparent that the exemplary embodiments of this invention provide a method, apparatus and computer program product(s) to map various control channels for downlink transmission to the UEs 10.

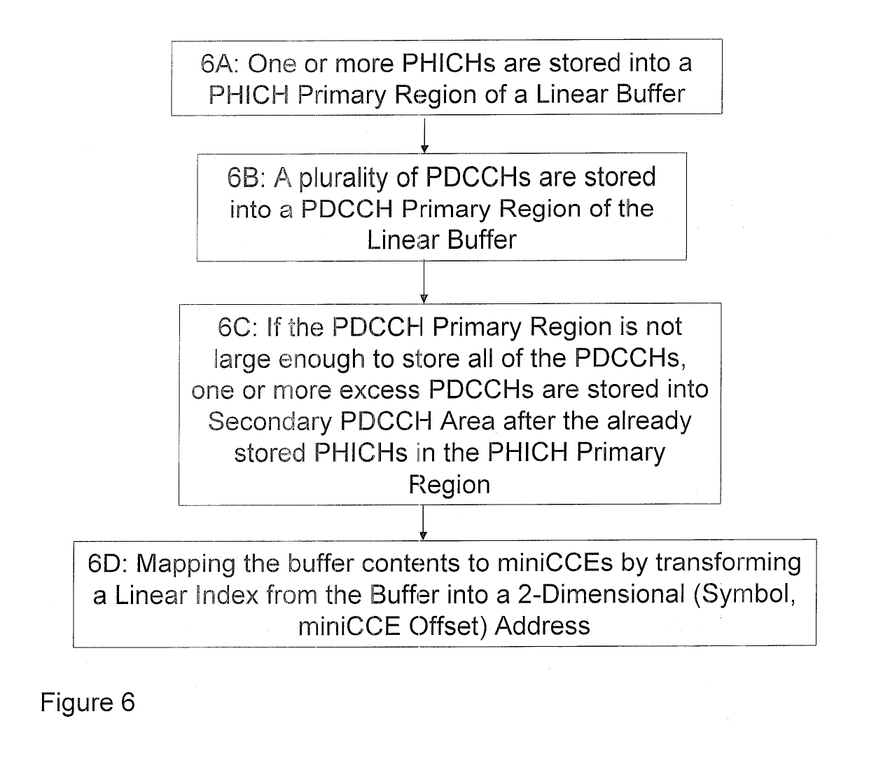

Referring to FIG. 6, which illustrates a logic flow diagram in accordance with a method and the operation of a computer program, in accordance with an exemplary embodiment of this invention at Block 6A one or more PHICHs are stored into a PHICH primary region of a linear buffer, at Block 6B a plurality of PDCCHs are stored into a PDCCH primary region of the linear buffer and, at Block 6C, if the PDCCH primary region is not large enough to store all of the PDCCHs, one or more excess PDCCHs are stored into a secondary PDCCH area after the already stored PHICHs in the PHICH primary region. At Block 6D the method continues by mapping the buffer contents to miniCCEs by transforming a linear index from the buffer into a 2-dimensional (symbol, miniCCE offset) address.

In accordance with the method and operation of the computer program of the preceding paragraph, the mapping is accomplished in a diagonal manner, where adjacent indices are mapped to different parts of the frequency band, where a move from one index to another is defined by a step size, where the step size is a prime number and dependent on the bandwidth.

In accordance with the method and operation of the computer program of the preceding paragraphs, the PCFICH is mapped to a first control symbol.

The various blocks shown in FIG. 6 may be viewed as method steps, and/or as operations that result from operation of computer program code, and/or as a plurality of coupled logic circuit elements constructed to carry out the associated function(s).

The exemplary embodiments of this invention further provide for the UE 10 to receive and properly decode the DL control channel signaling from the eNB 12.

Certain exemplary embodiments of this invention present a mapping scheme that satisfies existing and future requirements and provides technical effects including:

complying with different scenarios like different number of control symbols, different number of PHICH symbols, different reference signal scenarios.

efficiently utilizing all resources,

adhering to previous decisions on basic mapping requirements,

not needing PHICH configuration parameters in the P-BCH and D-BCH which can be read without any prior knowledge about the PHICH configuration, and

implementing algorithms in a generic and bandwidth independent way, which uses only simple arithmetic operations (add, subtract, compare), where both hardware and software implementations are feasible.

In addition, various exemplary embodiments of this invention provide these technical effects:

a PCFICH, which is positioned independently in the first OFDM symbol in known locations, is not part of the described mapping process,

the actual number of PHICHs that are available and that is set semi statically,

that the resources are divided into the primary PHICH region and the primary PDCCH region,

that the primary PHICH region is further divided into two sub regions called the effective PHICH area and the secondary PDCCH area,

that the primary PHICH- and the PDCCH-regions are implicitly known from the bandwidth (and are independent on the semi static setting), and

that the mapping to miniCCEs is done by transforming the linear index from the buffer to a 2-dimensional (symbol, miniCCE offset) in a diagonal manner using a step size which is bandwidth dependent.

In accordance with an exemplary embodiment of the invention it understood that memory such as the MEMS 10B, 12B, and 14B can be configured to include a linear buffer and/or other allocated memory space for storing data including, but not limited to, the control channel elements and the PCFICH, PHICH, and PDCCH. Further, said memory is accessible by a transmitter or a receiver or other components which may be coupled to the transmitter or receiver in order to input, output, compile, and/or retrieve stored data so as to perform, implement or execute a method, computer program, or apparatus in accordance with the exemplary embodiments of the invention.

Further, it is noted the various names used for the input and output parameters (e.g., input, output, retrieve, store, compile, etc.) are not intended to be limiting in any respect, as these parameters may be identified by any suitable names.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules that are designed to be fabricated as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. Further, the specific terminology such as PCFICH, PHICH, PDCCH, and the like are for clearer explanation of specific LTE-type embodiments and are not limiting to these teachings.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
storing one or more first channels in a first primary region of a linear buffer;
storing one or more second channels in a second primary region of the linear buffer, wherein if the second primary region is not large enough to store the second channels, one or more excess second channels are stored in a secondary area of the linear buffer; and
mapping contents of the linear buffer to mini control channel elements by transforming a linear index from the linear buffer to a 2-dimensional address.

2-26. (canceled)

27. The method according to claim 1, wherein the transforming is accomplished in a diagonal manner using a step size which is bandwidth dependent.

28. The method according to claim 1, in which the 2-dimensional address is a symbol, mini control channel element offset address.

29. The method according to claim 1, wherein the one or more first channels comprise a physical hybrid-ARQ indicator channel, and the one or more second channels comprises a physical downlink control channel.

30. The method according to claim 1, wherein the first primary region is divided into two sub regions comprising an effective first channel area, and the secondary area where the one or more excess second channels are stored.

31. The method according to claim 30, wherein a border between the primary first channel region and the primary second channel region of the linear buffer is implicitly known from a system bandwidth and corresponds to a maximum number of the first channels which can be stored in the linear buffer.

32. A computer program product comprising a computer-readable medium bearing computer program code embodied therein for use with a computer, the computer program code comprising:
code for storing one or more first channels in a first primary region of a linear buffer;
code for storing one or more second channels in a second primary region of the linear buffer, where if the second primary region is not large enough to store the second channels, one or more excess second channels are stored in a secondary area of the linear buffer; and
code for mapping contents of the linear buffer to mini control channel elements by transforming a linear index from the linear buffer to a 2-dimensional address.

33. The computer program product according to claim 32, wherein the transforming is accomplished in a diagonal manner using a step size which is bandwidth dependent.

34. The computer program product according to claim 32, wherein the first primary region is divided into two sub regions comprising an effective first channel area, and the secondary area where the one or more excess second channel are stored.

35. An apparatus comprising:
a memory;
a controller configured to store one or more first channels in a first primary region of a linear buffer in the memory;
the controller further configured to store one or more second channels in a second primary region of the linear buffer;
the controller further configured to respond to a condition where the second primary region is not large enough to store the second channels, to store one or more excess second channels in a secondary area of the linear buffer in the memory; and
the controller further configured to map contents of the linear buffer to mini control channel elements by transforming a linear index from the linear buffer to a 2-dimensional address.

36. The apparatus according to claim 35, wherein the transforming is accomplished in a diagonal manner using a step size which is bandwidth dependent.

37. The apparatus according to claim 35, in which the 2-dimensional address is a symbol, mini control channel element offset address.

38. The apparatus according to claim 35, wherein the one or more first channels comprise a physical hybrid-ARQ indicator channel, and the one or more second channels comprises a physical downlink control channel.

39. The apparatus according to claim 35, wherein the first primary region is divided into two sub regions comprising an effective first channel area, and the secondary area where the one or more excess second channels are stored.

40. The apparatus according to claim 39, wherein a border between the primary first channel region and the primary second channel region of the linear buffer is implicitly known from a system bandwidth and corresponds to a maximum number of the first channels which can be stored.
